(19) United States
(12) Patent Application Publication
(10) Pub. No.: US 2023/0201638 A1
(43) Pub. Date: Jun. 29, 2023

(54) SAFETY HOOK FASTENING CONDITION PREDICTION SYSTEM

(71) Applicant: ELSSEN CO., LTD., Daejeon (KR)

(72) Inventor: Jiman PARK, Daejeon (KR)

(21) Appl. No.: 17/668,784

(22) Filed: Feb. 10, 2022

(30) Foreign Application Priority Data
Dec. 23, 2021 (KR) 10-2021-0186041

(51) Int. Cl. A62B 35/00; F16B 45/02; G08B 21/02

(52) U.S. Cl. CPC A62B 35/0025; F16B 45/023; F16B 45/024; G08B 21/02

(57) ABSTRACT

Provided is a safety hook fastening condition prediction system. More particularly, provided is a safety hook fastening condition prediction system that provides a central axis to a conventional safety hook zone, attaches a safety hook fastening case to the central axis, senses a safety hook fastening condition using sensor values of a pressure sensor, a movement sensor, and an altitude sensor in the safety hook fastening case, and predicts a risk.

### CROSS-REFERENCE TO RELATED APPLICATION

This application claims priority to Korean Patent Application No. 10-2021-0186041, filed Dec. 23, 2021. The contents of the above application(s) are incorporated by reference in their entirety.

### FIELD OF THE INVENTION

Example embodiments relate to a safety hook fastening condition prediction system, and more particularly, to a safety hook fastening condition prediction system that provides a central axis to a conventional safety hook zone, attaches a safety hook fastening case to the central axis, senses a safety hook fastening condition using sensor values of a pressure sensor, a movement sensor, and an altitude sensor in the safety hook fastening case, and predicts a risk.

### DESCRIPTION OF THE RELATED ART

As an example of the related art that is related to a safety hook fastening condition prediction system of the invention, Patent Document 1 that is Korean Patent Registration No. 10-1701988 titled “luminous safety hook and safety belt using thereof” provides a non-contact sensor and a contact sensor to a hook, such that, when the hook is fastened to a fall prevention structure, a light source provided with a sensor turns on to generate light and thereby inspire safety awareness and a field manager as well as a corresponding user ensures even from a distance that the hook is properly fastened to the fall prevention structure. In this manner, a safety accident such as fall may be prevented.

Also, Patent Document 2 that is Korean Patent Laid-Open Publication No. 10-2021-0022264 titled “safety belt unit for high place work” may sense movement of an operator at height and movement of a safety ring and through this, may induce correct fastening of the safety ring to the operator at height who is reluctant to intentionally fasten the safety ring and a safety structure due to work inconvenience, safety frigidity, lack of awareness, etc.

Also, Patent Document 3 that is Korean Patent Laid-Open Publication No. 10-2021-0144316 titled “apparatus and method for detecting fastening condition of safety hook” ensures safety of an operator using a light and miniaturized device in consideration of specificity of a construction site.

However, a conventional safety hook fastening condition prediction system may not sense pressure and presence or absence of an object that is placed in a locking space under any conditions by connecting a safety hook zone and a safety hook sensor case through a central axis of the present invention.

### SUMMARY OF THE INVENTION

At least one example embodiment provides a safety hook fastening condition prediction system that may sense pressure and presence or absence of an object placed in a locking space under any conditions by connecting a safety hook zone and a safety hook sensor case through a central axis and thereby accurately determine a safety hook fastening condition and predict a risk.

Also, at least one example embodiment provides a safety hook fastening condition prediction system that may accurately determine a safety hook fastening condition through information analysis according to pressure, movement, and altitude by converging and fusing at least one of a pressure sensor, a movement sensor, and an altitude sensor.

Also, at least one example embodiment provides a safety hook fastening condition prediction system that may analyze information according to pressure, movement, and altitude using a machine learning algorithm and may predict a work pattern of an operator and a risk.

According to an aspect of at least one example embodiment there is provided a safety hook fastening condition prediction system including a safety hook sensor 40 configured to mount to a safety hook, to predict a fastening condition of the safety hook, and to transmit the fastening condition to a central control server 70 through a connection of a safety hook zone and a safety hook sensor case 17 through a central axis 12; and the central control server 70 configured to collect the fastening condition of the safety hook sensor 40 and to manage a safety of an operator based on collected information.

Also, the central axis 12 may be formed on a curved body portion that bends outward from a locking space 101 of the safety hook zone and is configured to sense pressure in all of a vertical direction and a horizontal direction.

Also, a hole may be formed in the safety hook zone to form the central axis 12.

Also, a spring 11 may be configured to insert into a spring insertion groove 10 and to increase elasticity and reliability for pressure sensing between the safety hook zone and the safety hook sensor case 17.

Also, the safety hook sensor 40 may be configured to mount to the safety hook, to predict the fastening condition of the safety hook, and to transmit the fastening condition to a wearable sensor 50, the wearable sensor 50 may be configured to receive the fastening condition from the safety hook sensor 40 and to transmit the same to the central control server 70 through a gateway 60, and the central control server 70 may be configured to collect the fastening condition of the safety hook sensor 40 and to manage the safety of the operator based on the collected information.

Also, the safety hook sensor 40 may include a pressure sensor 16, and the pressure sensor 16 may include a printed circuit board (PCB) 32 configured to sense pressure; a conductive silicone 31 having elasticity; and a silicone pressure case 33 having elasticity configured and configured to surround the PCB 32 and the conductive silicone 31.

Also, the safety hook sensor 40 may include a pressure sensor 16, and the pressure sensor 16 may include a PCB 32 including switches and resistances capable of sensing pressure; and a silicone pressure case 33 having elasticity and configured to surround the PCB 32.

Also, the safety hook sensor 40 may be configured to perform operation S101 of sensing pressure; operation S102 of determining that the safety hook is fastened when the pressure is sensed; operation S103 of determining that the safety hook is not fastened when the pressure is not sensed; operation S104 of determining whether a pressure change is present during a predetermined period of time when the safety hook is fastened; operation S105 of determining a corresponding situation as an operator pressure condition manipulation when the pressure change is absent; operation S106 of determining a corresponding situation as a risk situation; and operation S107 of determining a corresponding situation as a normal fastening when the pressure change is present.

Also, the safety hook sensor 40 may be configured to perform operation S301 of sensing movement; operation S302 of sensing altitude; operation S303 of determining that the safety hook is in a moving state when a danger area is yes and the movement is sensed; operation S304 of determining that the safety hook is in a stop state when the danger area is no and the movement is not sensed; operation S305 of sensing pressure; operation S306 of determining that the safety hook is fastened when the pressure is sensed; operation S308 of determining whether a pressure change is present during a predetermined period of time when the safety hook is fastened; operation S309 of determining a corresponding situation as an operator pressure condition manipulation when the pressure change is absent; operation S310 of determining a corresponding situation as a risk situation; operation S311 of determining a corresponding situation as a normal fastening when the pressure change is present; operation S307 of determining that the safety hook is not fastened when the pressure is not sensed; operation S312 of determining whether a movement change is present during a predetermined period of time when the safety hook is not fastened; operation S313 of determining a corresponding situation as a risk situation when the movement change is present; and operation S314 of determining that the safety hook is not used when the movement change is absent.

Also, the safety hook sensor 40 may be configured to perform operation S201 of sensing movement; operation S202 of determining that the operator or the safety hook is in a moving state when the movement is sensed; operation S203 of determining that the operator or the safety hook is in a stop state when the movement is not sensed; operation S205 of sensing pressure; operation S206 of sensing an object using an infrared (IR) sensor; operation S207 of determining that the safety hook is fastened when the object or the pressure is sensed; operation S208 of determining that the safety hook is not fastened when the object or the pressure is not sensed; operation S209 of determining whether the pressure change is present during a predetermined period of time when the safety hook is fastened; operation S210 of determining a corresponding situation as an operator pressure condition manipulation when the pressure change is absent; operation S211 of determining a corresponding situation as a risk situation; operation S212 of determining a corresponding situation as a normal fastening when the pressure change is present; operation S213 of determining whether a movement change is present during a predetermined period of time when the safety hook is not fastened; operation S215 of determining a corresponding situation as a risk situation when the movement change is present; and operation S214 of determining that the safety hook is not used when the movement change is absent.

Also, the safety hook sensor 40 may be configured to perform operation S401 of sensing movement; operation S402 of sensing altitude; operation S403 of determining that the operator or the safety hook is in a moving state when a danger area is yes and the movement is sensed; operation S404 of determining that the operator or the safety hook is in a stop state when the danger area is no and the movement is not sensed; operation S405 of sensing an object using an IR sensor; operation S406 of determining that the safety hook is fastened when the object is sensed; operation S407 of determining that the safety hook is not fastened when the object is not sensed; operation S408 of determining whether a pressure change is present during a predetermined period of time when the safety hook is fastened; operation S409 of determining a corresponding situation as an operator pressure condition manipulation when the pressure change is absent; operation S410 of determining a corresponding situation as a risk situation; operation S411 of determining a corresponding situation as a normal fastening when the pressure change is present; operation S412 of determining whether a movement change is present during a predetermined period of time when the safety hook is not fastened; operation S413 of determining a corresponding situation as a risk situation when the movement change is present; operation S414 of determining that the safety hook is not used when the movement change is absent; and operation S415 of transmitting information to an operator sensor device.

Also, the safety hook sensor 40 may be configured to perform operation S501 of sensing movement; operation S502 of sensing altitude; operation S503 of determining that the operator or the safety hook is in a moving state when the movement is sensed; operation S504 of determining that the operator or the safety hook is in a stop state when the movement is not sensed; operation S505 of sensing pressure; operation S506 of sensing an object using an IR sensor; operation S507 of determining that the safety hook is fastened when the object or the pressure is sensed; operation S508 of determining that the safety hook is not fastened when the object or the pressure is not sensed; operation S509 of determining whether the pressure change is present during a predetermined period of time when the safety hook is fastened; operation S510 of determining a corresponding situation as an operator pressure condition manipulation when the pressure change is absent; operation S511 of determining a corresponding situation as a risk situation; operation S512 of determining a corresponding situation as a normal fastening when the pressure change is present; operation S513 of determining whether a movement change is present during a predetermined period of time when the safety hook is not fastened; operation S514 of determining a corresponding situation as a risk situation when the movement change is present; and operation S515 of determining that the safety hook is not used when the movement change is absent.

Also, the safety hook sensor 40 may be configured to monitor a change in a position of the operator using an altitude sensor and a reference altitude sensor and to provide an operator safety service based on at least one of a height of the operator, a reference point (ground), a safety hook fastening condition of the operator, a physical condition of the operator, and an environmental condition (weather).

Also, the safety hook sensor 40 may be configured to monitor a change in a position of the operator using a movement sensor and to provide an operator safety service based on at least one of a safety hook fastening condition of the operator, a physical condition of the operator, and an environmental condition (weather).

Also, the wearable sensor 50 may be configured to perform operation S601 of analyzing sensor information of a movement state and a pressure sensing state in the safety hook; operation S602 of sensing movement of the operator; operation S603 of determining that the movement state is yes and the pressure sensing state is yes in the safety hook when the movement is sensed; operation S604 of determining that the movement state is no and the pressure sensing state is no in the safety hook when the movement is not sensed; operation S605 of determining that the safety hook is not fastened when the movement state is no and the pressure sensing state is no; operation S606 of comparing the safety hook and a movement sensor of the operator; operation S607 of determining that the safety hook is abnormally fastened when a movement sensor value is within a specific range; operation S608 of determining that the safety hook is normally fastened when the movement sensor value is outside the specific range; operation S609 of sensing altitude; operation S610 of providing a notification of fastening the safety hook according to the altitude; operation S611 of sensing air quality; and operation S612 of notifying a work safety according to conditions of various sensors.

According to some example embodiments, it is possible to sense pressure and presence or absence of an object that is placed in a locking space under any conditions by connecting a safety hook zone and a safety hook sensor case through a central axis and thereby accurately determine a safety hook fastening condition and predict a risk.

Also, according to some example embodiments, it is possible to accurately determine a safety hook fastening condition through information analysis according to pressure, movement, and altitude by converging and fusing at least one of a pressure sensor, a movement sensor, and an altitude sensor.

Also, according to some example embodiments, it is possible to predict a work pattern of an operator and a risk by analyzing information according to pressure, movement, and altitude using a machine learning algorithm.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

These and/or other aspects, features, and advantages of the invention will become apparent and more readily appreciated from the following description of embodiments, taken in conjunction with the accompanying drawings of which:

FIG. 1 illustrates an example of a configuration of a safety hook con according to an example embodiment;

FIG. 2 illustrates an example of a configuration of a sensor of a safety hook fastening accident prevention system according to an example embodiment;

FIG. 3 illustrates an example of a configuration of a pressure sensor of a safety hook fastening accident prevention system according to an example embodiment;

FIG. 4 is a rear view and a cross-sectional view of a pressure sensor of a safety hook fastening accident prevention system according to an example embodiment;

FIG. 5 is a top view and a cross-sectional view of a pressure sensor of a safety hook fastening accident prevention system according to an example embodiment;

FIG. 6 is a flowchart illustrating a first embodiment of a pressure sensor-based safety hook fastening accident prevention method according to an example embodiment;

FIG. 7 is a flowchart illustrating a second embodiment of a pressure sensor-based safety hook fastening accident prevention method according to an example embodiment;

FIG. 8 is a flowchart illustrating a first embodiment of a pressure and infrared (IR) sensor-based safety hook fastening accident prevention method according to an example embodiment;

FIG. 9 is a flowchart illustrating a second embodiment of a pressure and IR sensor-based safety hook fastening accident prevention method according to an example embodiment;

FIG. 10 is a flowchart illustrating a third embodiment of a pressure and IR-sensor-based safety hook fastening accident prevention method according to an example embodiment;

FIG. 11 is a flowchart illustrating an example of a safety hook fastening accident prevention method of a wearable sensor according to an example embodiment;

FIG. 12 is a diagram illustrating an example of a safety hook sensor and a wearable sensor according to an example embodiment;

FIG. 13 illustrates a first embodiment of a safety hook fastening accident prevention system according to an example embodiment;

FIG. 14 illustrates a second embodiment of a safety hook fastening accident prevention system according to an example embodiment;

FIG. 15 illustrates a third embodiment of a safety hook fastening accident prevention system according to an example embodiment;

FIG. 16 illustrates an example of an Internet of things (IoT) configuration of a safety hook fastening accident prevention system according to an example embodiment;

FIG. 17 is a diagram illustrating an example of an operation of a hardware resource, an operating system (OS), a controller that is a core, and a system authentication configuration to grant authority for executing the controller according to an example embodiment; and

FIG. 18 illustrates an example of applying a neural network according to an example embodiment.

### DETAILED DESCRIPTION OF THE INVENTION

One or more example embodiments will be described with reference to the accompanying drawings. Advantages and features of the example embodiments, and methods for achieving the same may become explicit by referring to the accompanying drawings and the following example embodiments. Example embodiments, however, may be embodied in various different forms, and should not be construed as being limited to only the illustrated embodiments.

Hereinafter, a safety hook fastening accident prevention system according to example embodiments is described with reference to the accompanying drawings. Hereinafter, description related to the known matters will be omitted or simplified for clarity of description. Components described herein may operate individually or in combination.

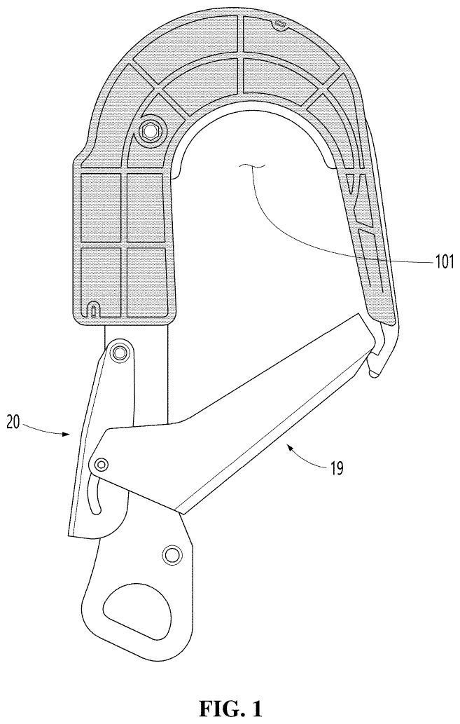

FIG. 1 illustrates an example of a configuration of a safety hook according to an example embodiment. Referring to FIG. 1, the safety hook includes a locking space 101, an opening/closing clip 19, and an interlocking clip 20.

The locking space 101 corresponds to a portion that stops a safety bar and a cable in the safety hook. When the safety bar or the cable is stopped in the locking space 101, the opening/closing clip 19 serves to allow the safety bar or the cable to pass and to close the locking space 101. The interlocking clip 20 provides an elasticity to move the opening/closing clip 19 outward and to close the locking space 101 accordingly.

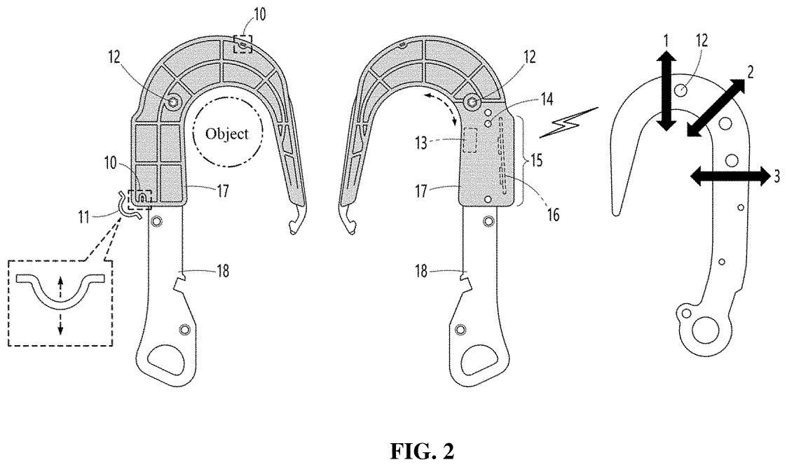

FIG. 2 illustrates an example of a configuration of a sensor of a safety hook fastening accident prevention system according to an example embodiment. Referring to FIG. 2, the safety hook includes a leaf spring insertion groove 10, a leaf spring 11, a central axis 12 of a safety hook sensor case 17, an infrared (IR) sensor 13, a light emitting diode (LED) 14, a sensor & communication module 15, a pressure sensor 16, the safety hook sensor case 17, and a safety knob 18.

The leaf spring 11 inserts into the leaf spring insertion groove 10, the central axis 12 is that of the safety hook sensor case 17, the IR sensor 13 measures a distance from an object placed in the locking space 101, the LED 14 is an indicator, the sensor & communication module 15 transmits a sensor value of the IR sensor 13 or the pressure sensor 16 to the wearable sensor 50 or the central control server 70, the pressure sensor 16 measures applied pressure, the safety hook sensor case 17 is connected to the safety hook zone through the central axis 12 and thereby forms the locking space 101 to receive various types of parts, and the safety knob 18 is a handle that extends from the safety hook sensor case 17 and the safety hook zone of the locking space 101.

A safety hook sensor 40 forms the central axis 12 in the conventional safety hook zone. The central axis 12 has a size that allows the safety hook sensor case 17 to smoothly operate without affecting a safety. For example, a hole of about 3 mm may be formed in the central axis 12. Also, a position that allows smooth fastening sensing when the safety hook is fastened needs to be selected. The central axis 12 is formed on a curved boy portion that bends outward from the locking space 101 of the safety hook zone and is configured to sense pressure in all of a vertical direction and a horizontal direction.

The central axis 12 is a device that connects the conventional safety hook zone and the safety hook sensor case 17 and is configured as a form of a sensor operation. The central axis 12 of number 1 operates by up-and-down, that is, vertical pressure, the central axis 12 of number 3 operates by left-and-right, that is, horizontal pressure, and the central axis 12 of number 2 operates by vertical and horizontal pressure. When an iron bar and a rope are fastened to the locking space 101 of the safety hook, the pressure sensor 16 operates by pressure caused by a weight of the safety hook or by pulling pressure of an operator. Also, for the central axis 12 of number 2, the rope and the iron bar apply the pressure in a direction corresponding to number 1 in many cases and sometimes apply the pressure in a direction corresponding to number 3. Even here, although the pressure is applied in a direction corresponding to number 2, the central axis 12 of number 2 moves in the direction corresponding to number 1 and the pressure is sensed accordingly. The central axis 12 of number 2 is provided at a midpoint at which all of a vertical movement and a horizontal movement occur in a curved body of a safety hook zone body.

The leaf spring 11 inserts into the leaf spring insertion groove 10 and increases elasticity and reliability for pressure sensing between the safety hook zone and the safety hook sensor case 17. Two leaf springs 11 are provided and insert in an upper portion and a lower portion of the safety hook, respectively. Strength of the leaf spring 11 is set based on the pressure that is applied to the safety hook when the safety hook moves left and right in pressure sensing. A tension spring, a coil spring, and a spiral spring may be used instead of using the leaf spring 11. The leaf spring 11 allows the pressure sensor 16 to be placed at a neutral position and, if the pressure does not change for a long time, determines that the safety hook is not used. If the leaf spring 11 is absent, the pressure sensor 16 may be formed with a specific value through contact with the safety hook zone. Therefore, the leaf spring 11 improves the reliability for a pressure value according to safety hook fastening.

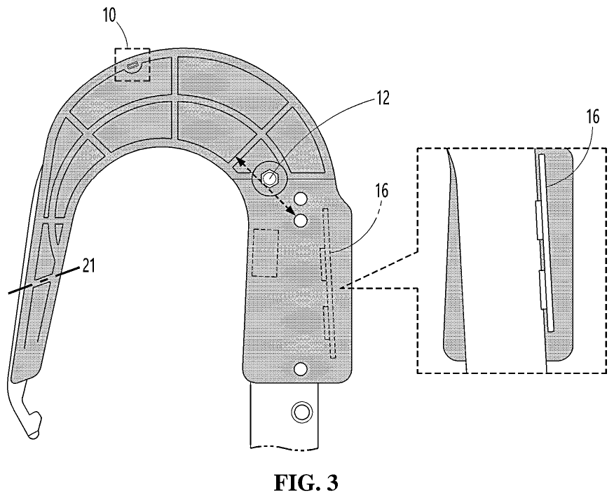

FIG. 3 illustrates an example of a configuration of a pressure sensor of a safety hook fastening accident prevention system according to an example embodiment. Referring to FIG. 3, the safety hook includes the leaf spring insertion groove 10, the central axis 12 of the safety hook sensor case 17, the pressure sensor 16, and a perforated line 21.

FIG. 4 is a rear view and a cross-sectional view of a pressure sensor of a safety hook fastening accident prevention system according to an example embodiment. Referring to FIG. 4, the pressure sensor 16 may include a conductive silicone 31, a printed circuit board (PCB) 32, and a silicone pressure case 33.

The pressure sensor 16 includes the PCB 32 configured to sense pressure, the conductive silicone 31 having elasticity, and the silicone pressure case 33 having elasticity and configured to surround the PCB 32 and the conductive silicone 31. That is, when the conductive silicone 31 having resistance inserts into the silicone pressure case 33 in a structure capable of sensing the pressure and inserts into the PCB 32 in a pattern in which electricity flows, the pressure sensor 16 is formed. When the pressure sensor 16 is completed and the silicone pressure case 33 is pressed, a resistance value varies according to pressing strength. When not pressed, an infinite value is sensed. When pressed, a resistance value gradually decreases.

Also, the pressure sensor 16 includes P1 and P2. That is, although the pressure sensor 16 may include P1 alone, the pressure sensor 16 includes P1 and P2 to accurately sense a change in the pressure. To this end, P1 and P2 in which a ground pattern is commonly used are configured on a single PCB 32. When installing the safety hook, the pressure is sequentially transferred to P2 and P2 and a resistance value according to the pressure is sensed differently. Through this, the change in the pressure is sensed and whether the safety hook is normally fastened or abnormally fastened may be determined.

When an operator fastens the safety hook, a resistance value according to pressure varies. The resistance value varies according to a work type, that is, a safety hook fastening type. A fastening type and a fall of the operator may be discerned depending on whether a change in the resistance value is great, small, or absent. For example, in a situation in which the safety hook is fastened, if pressure is strong and a resistance value stays at a low value for a predetermined period of time, a fall of the operator while working may be determined. Also, in a situation in which the safety hook is fastened, if the pressure appears to be maintained constant to some extents, it is determined that the safety hook is abnormally fastened.

Although the pressure sensor 16 including a plurality of switches and resistances is used, a pressure sensor configured as the conductive silicone 31 and a pressure sensor configured as a switch and a resistance may be fused and thereby used. This improves reliability for fastening by pressure and clarifies sensing of fake and poor fastening.

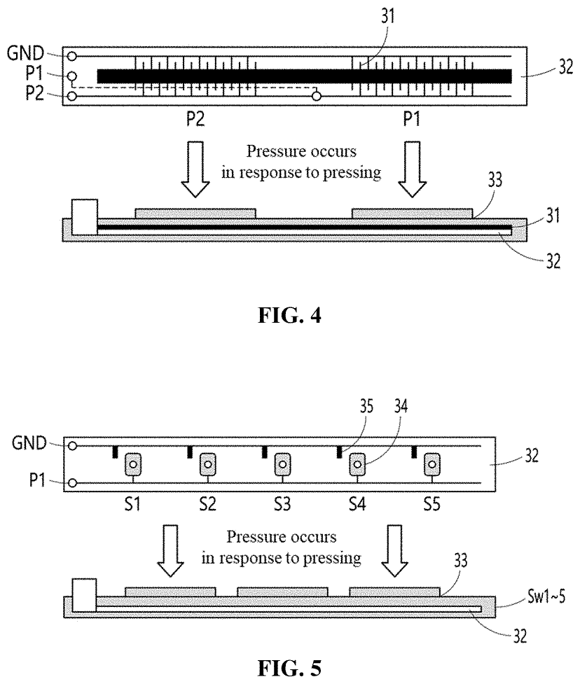

FIG. 5 is a top view and a cross-sectional view of a pressure sensor of a safety hook fastening accident prevention system according to an example embodiment. Referring to FIG. 5, the pressure sensor 16 includes the PCB 32, the silicone pressure case 33, a switch 34, and a resistance 35.

The pressure sensor 16 includes a plurality of switches 34 and a plurality of resistances 35. Five switches 34, for example, (S1, R1), (S2, R2), . . . (Sn, Rn), may be used to improve accuracy. The pressure sensor 16 determines whether the safety hook is normally fastened or abnormally fastened by sensing the pressure change.

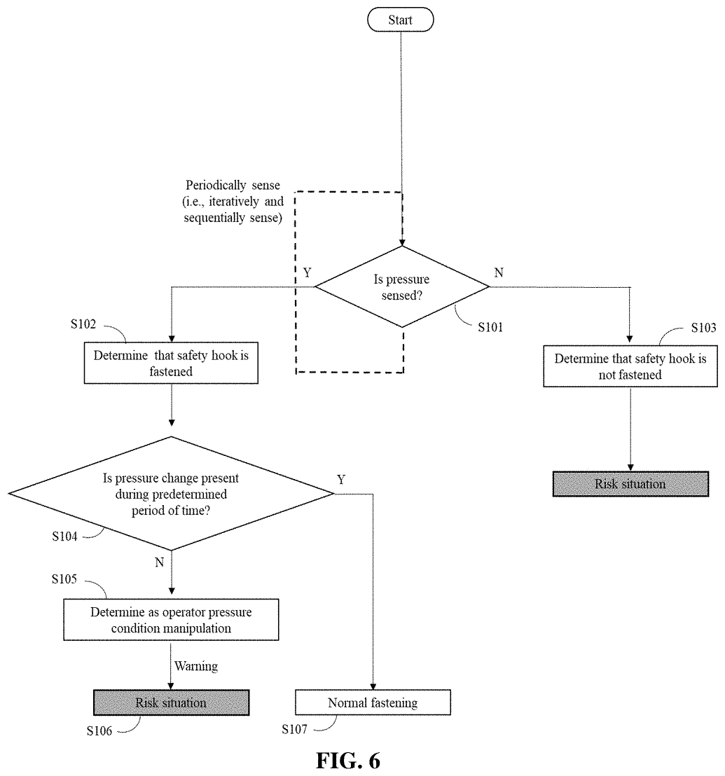

FIG. 6 is a flowchart illustrating a first embodiment of a pressure sensor-based safety hook fastening accident prevention method according to an example embodiment. Referring to FIG. 6, the safety hook sensor 40 performs operation S101 of sensing pressure, operation S102 of determining that the safety hook is fastened when the pressure is sensed, operation S103 of determining that the safety hook is not fastened when the pressure is not sensed, operation S104 of determining whether a pressure change is present during a predetermined period of time when the safety hook is fastened, operation S105 of determining a corresponding situation as an operator pressure condition manipulation when the pressure change is absent, operation S106 of determining a corresponding situation as a risk situation, and operation S107 of determining a corresponding situation as a normal fastening when the pressure change is present.

The most basic in safety hook fastening is to determine whether the safety hook is fastened based on the pressure sensor 16. When the safety hook is caught on an iron bar and a rope, pressure is sensed and recognized as fastening. Meanwhile, if the safety hook is artificially tied with a cable tie and the like, the safety hook sensor 40 may recognize it as the safety hook fastening, that is, may determine that the safety hook is fastened. If the operator behaves as if the operator has fastened the safety hook to facilitate a work, it is a dangerous behavior. In this case, the example embodiment performs pressure sensing periodically, analyzes a change in pressure sensor value related to the safety hook, and determines a fake fastening using the safety hook sensor 40.

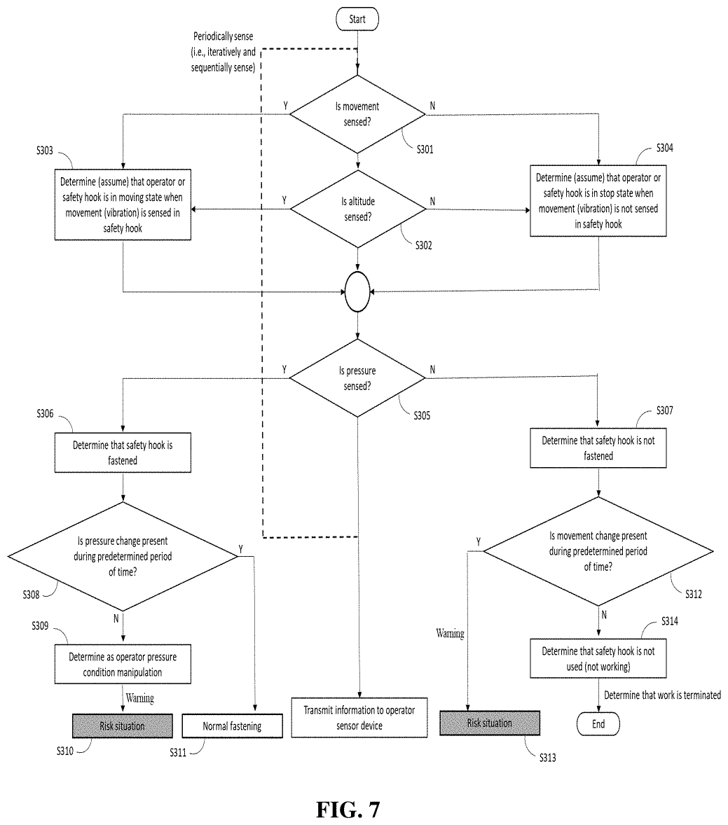

FIG. 7 is a flowchart illustrating a second embodiment of a pressure sensor-based safety hook fastening accident prevention method according to an example embodiment. Referring to FIG. 7, the safety hook sensor 40 performs operation S301 of sensing movement, operation S302 of sensing altitude, operation S303 of determining that the safety hook is in a moving state when the movement is sensed, operation S304 of determining that the safety hook is in a stop state when the movement is not sensed, operation S305 of sensing pressure, operation S306 of determining that the safety hook is fastened when the pressure is sensed, operation S308 of determining whether a pressure change is present during a predetermined period of time when the safety hook is fastened, operation S309 of determining a corresponding situation as an operator pressure condition manipulation when the pressure change is absent, operation S310 of determining a corresponding situation as a risk situation, operation S311 of determining a corresponding situation as a normal fastening when the pressure change is present, operation S307 of determining that the safety hook is not fastened when the pressure is not sensed, operation S312 of determining whether a movement change is present during a predetermined period of time when the safety hook is not fastened, operation S313 of determining a corresponding situation as a risk situation when the movement change is present, and operation S314 of determining that the safety hook is not used when the movement change is absent.

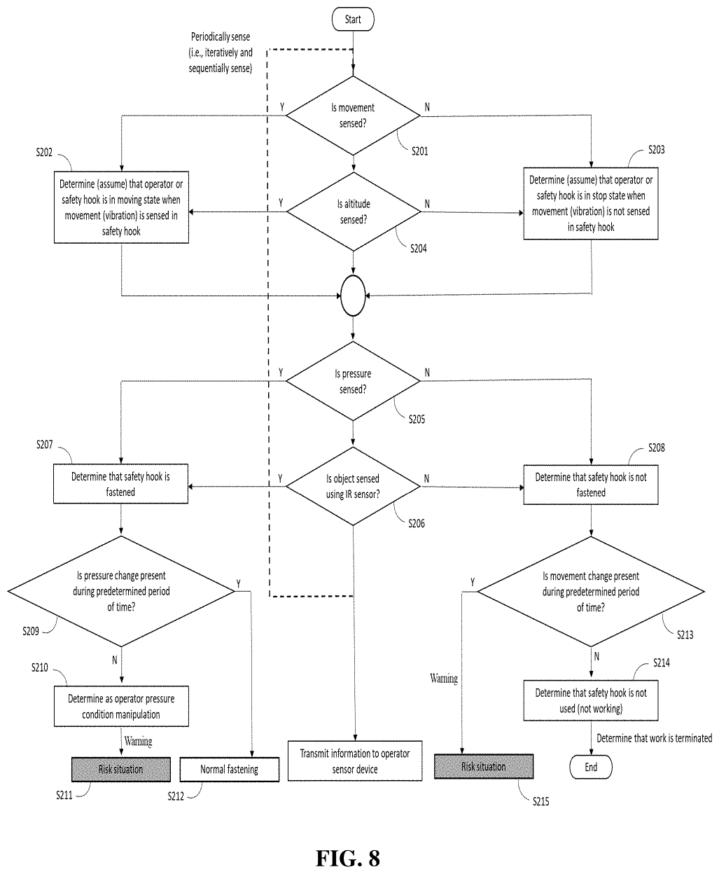

FIG. 8 is a flowchart illustrating a first embodiment of a pressure and IR sensor-based safety hook fastening accident prevention method according to an example embodiment. Referring to FIG. 8, the safety hook sensor 40 performs operation S201 of sensing movement, operation S204 of sensing altitude, operation S202 of determining that the operator or the safety hook is in a moving state when a danger area is yes and the movement is sensed, operation S203 of determining that the operator or the safety hook is in a stop state when the danger area is no and the movement is not sensed, operation S205 of sensing pressure, operation S206 of sensing an object using an IR sensor, operation S207 of determining that the safety hook is fastened when the pressure is sensed, operation S208 of determining that the safety hook is not fastened when the pressure is not sensed, operation S209 of determining whether the pressure change is present during a predetermined period of time when the safety hook is fastened, operation S210 of determining a corresponding situation as an operator pressure condition manipulation when the pressure change is absent, operation S211 of determining a corresponding situation as a risk situation, operation S212 of determining a corresponding situation as a normal fastening when the pressure change is present, operation S213 of determining whether a movement change is present during a predetermined period of time when the safety hook is not fastened, operation S215 of determining a corresponding situation as a risk situation when the movement change is present, and operation S214 of determining that the safety hook is not used when the movement change is absent.

Although sensing by the pressure sensor 16 is basically used in fastening, the pressure sensor 16 may not determine whether the safety hook is fastened when the safety hook is fastened to a slack rope or when working on a high-rise floor. As a method of solving this, an IR sensor 43 recognizes the rope placed in the safety hook and determines whether the safety hook is fastened. Here, the IR sensor 43 refers to a sensor configured to sense a distance and senses fastening by sensing a rope of about 1 cm in the safety hook.

As a sensor configured to sense fastening of the safety hook, the pressure sensor 16 and the IR sensor 43 may be used. A movement sensor 51 may determine a fastening condition for any event among whether the safety hook is correctly fastened, whether a corresponding situation corresponds to a risk situation, whether the safety hook is carried on a body of the operator, and a type of fastening. That is, when the movement is absent during a predetermined period of time, a safety hook fastening condition prediction system may determine a fastening condition by analyzing a change in values of the pressure sensor 16 and the IR sensor 43 and thus, may more accurately determine a safety hook fastening status. Also, the safety hook fastening condition prediction system may predict a risk of the operator by analyzing even a work pattern of the operator. For example, when the operator works on the roof of an apartment, the operator may install a rope on the floor and fasten the safety hook to the floor rope. In this case, it is difficult for the safety hook sensor 40 to determine a fastening condition using the pressure sensor 16. Therefore, the safety hook fastening condition prediction system may determine the fastening condition using the IR sensor 43 and may finally determine whether the safety hook is fastened based on a value of the movement sensor 51.

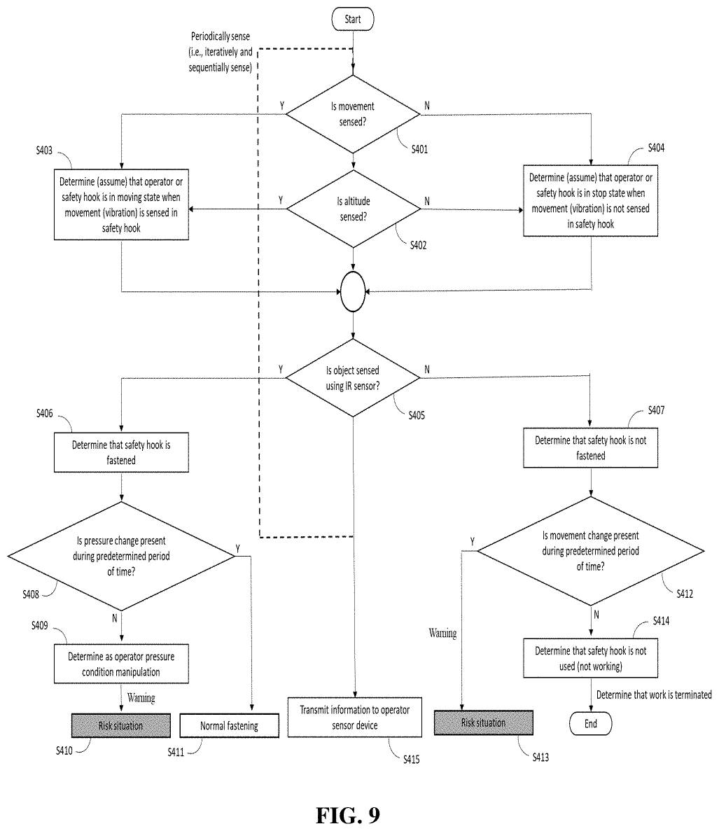

FIG. 9 is a flowchart illustrating a second embodiment of a pressure and IR sensor-based safety hook fastening accident prevention method according to an example embodiment. Referring to FIG. 9, the safety hook sensor 40 performs operation S401 of sensing movement, operation S402 of sensing altitude, operation S403 of determining that the operator or the safety hook is in a movement state when a danger area is yes and the movement is sensed, operation S404 of determining that the operator or the safety hook is in a stop state when the danger area is no and the movement is not sensed, operation S405 of sensing an object using an IR sensor, operation S406 of determining that the safety hook is fastened when the object is sensed, operation S407 of determining that the safety hook is not fastened when the object is not sensed, operation S408 of determining whether a pressure change is present during a predetermined period of time when the safety hook is fastened, operation S409 of determining a corresponding situation as an operator pressure condition manipulation when the pressure change is absent, operation S410 of determining a corresponding situation as a risk situation, operation S411 of determining a corresponding situation as a normal fastening when the pressure change is present, operation S412 of determining whether a movement change is present during a predetermined period of time when the safety hook is not fastened, operation S413 of determining a corresponding situation as a risk situation when the movement change is present, operation S414 of determining that the safety hook is not used when the movement change is absent, and operation S415 of transmitting information to an operator sensor device.

Once the pressure is sensed, the safety hook sensor 40 recognizes a corresponding situation as a safety hook fastening, that is, determines that the safety hook is fastened. Here, the IR sensor 43 is used as an option. When the pressure sensor 16 is not sensed, the movement sensor 51 has a specific value. When a value of an altitude sensor 53 is recognized as a significant height, the safety hook sensor 40 may determine whether the safety hook is fastened by operating the IR sensor 43.

The example embodiment may determine whether the safety hook is fastened by overall converging and fusing the pressure sensor 16, the IR sensor 43, the movement sensor 51, the altitude sensor 53, and the like, and may execute a fastening prediction service by selecting and applying an optimal sensor according to field service requirements, that is, a user demand.

Also, when determining whether the safety hook is fastened, the pressure sensor 16 and the IR sensor 43 may be simultaneously used. Alternatively, one of the pressure sensor 16 and the IR sensor 43 may be used. If a plurality of sensors is used, battery consumption may increase, which may cause a user to feel inconvenient in replacing a battery.

Also, when determining whether the safety hook is fastened, the danger area may be determined based on a height. Here, the altitude sensor 53 determines whether a corresponding workplace corresponds to the danger area. It is assumed that working at the height of 2 m or more from the ground corresponds to the danger area. Also, when the movement is sensed, it is assumed that the operator is working in the danger area. Based on this, the safety hook fastening condition prediction system may perform a comparative analysis on a value of the pressure sensor 16 and a value of the IR sensor 43 and may determine a fastening status intelligently.

Also, the altitude sensor 53 measures an altitude value according to normal altitude. A safety hook fastening condition prediction system according to the altitude value may be performed. A reference altitude sensor may be installed at a construction site. If comparison therewith shows a corresponding difference as an altitude value of 2 m or more, an intelligent system connectable with the safety hook sensor 40 may be provided. For example, when a reference altitude value of the construction site is transmitted to a server and a safety hook altitude value of the operator is also transmitted to the server, the central control server 70 may analyze a risk status according to the altitude difference through comparative analysis. Here, a more accurate situation may be serviced using a value of the safety hook sensor 40.

The safety hook sensor 40 monitors a change in a position of the operator through an altitude sensor and the reference altitude sensor and provides an operator safety service based on at least one of a height of the operator, a reference point (ground), a safety hook fastening condition of the operator, a physical condition of the operator, and an environmental condition (weather). The greater the height of the operator and the height of the reference point (ground), the higher the risk. However, the safety hook fastening condition prediction system monitors a position of the operator and a reference point and induces safety by shifting the reference point according to a construction work. It is said that most of current fall fatalities fall to death within 5 m, which is thought to be relatively low, and accidents occur by mistake without the safety hook being fastened.

Also, the safety hook sensor 40 monitors a change in a position of the operator using a movement sensor and provides an operator safety service based on at least one of a safety hook fastening condition of the operator, a physical condition of the operator, and an environmental condition (weather). The operator may move quickly or very slowly at high altitude. The safety hook fastening condition prediction system may regard appearance of a pattern different from a movement in a normal work, that is, a movement speed during a specific period of time and a movement type as a risk and may predict the same as a very high risk of falling.

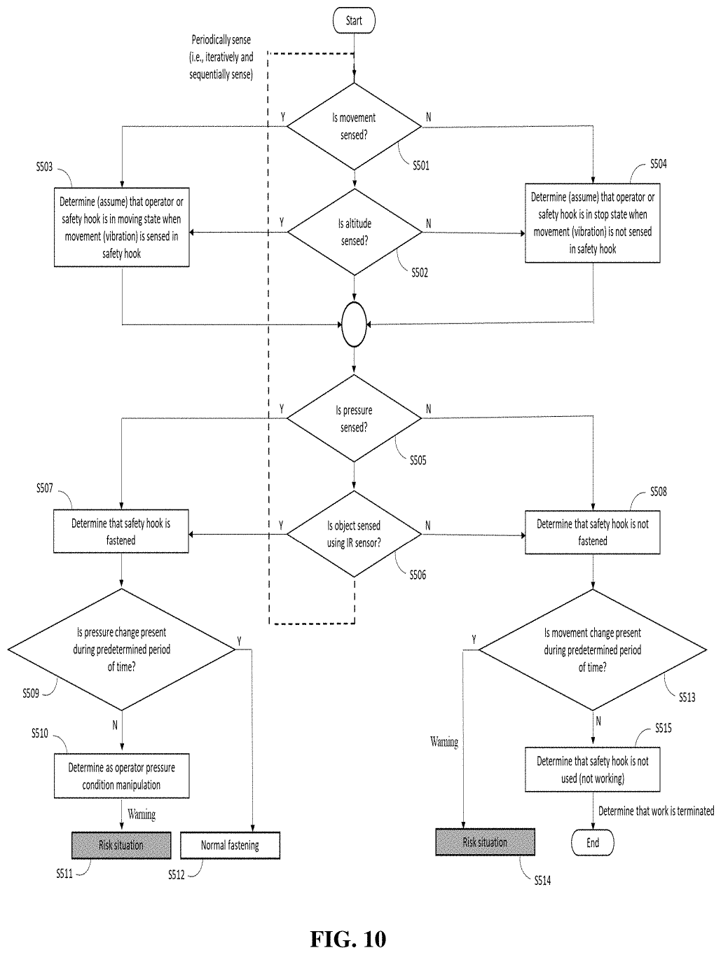

FIG. 10 is a flowchart illustrating a third embodiment of a pressure and IR-sensor-based safety hook fastening accident prevention method according to an example embodiment. Referring to FIG. 10, the safety hook sensor 40 performs operation S501 of sensing movement, operation S502 of sensing altitude, operation S503 of determining that the operator or the safety hook is in a moving state when a danger area is yes and the movement is sensed, operation S504 of determining that the operator or the safety hook is in a stop state when the danger area is no and the movement is not sensed, operation S505 of sensing pressure, operation S506 of sensing an object using an IR sensor, operation S507 of determining that the safety hook is fastened when the object and the pressure are sensed, operation S508 of determining that the safety hook is not fastened when the object and the pressure are not sensed, operation S509 of determining whether the pressure change is present during a predetermined period of time when the safety hook is fastened, operation S510 of determining a corresponding situation as an operator pressure condition manipulation when the pressure change is absent, operation S511 of determining a corresponding situation as a risk situation, operation S512 of determining a corresponding situation as a normal fastening when the pressure change is present, operation S513 of determining whether a movement change is present during a predetermined period of time when the safety hook is not fastened, operation S514 of determining a corresponding situation as a risk situation when the movement change is present, and operation S515 of determining that the safety hook is not used when the movement change is absent.

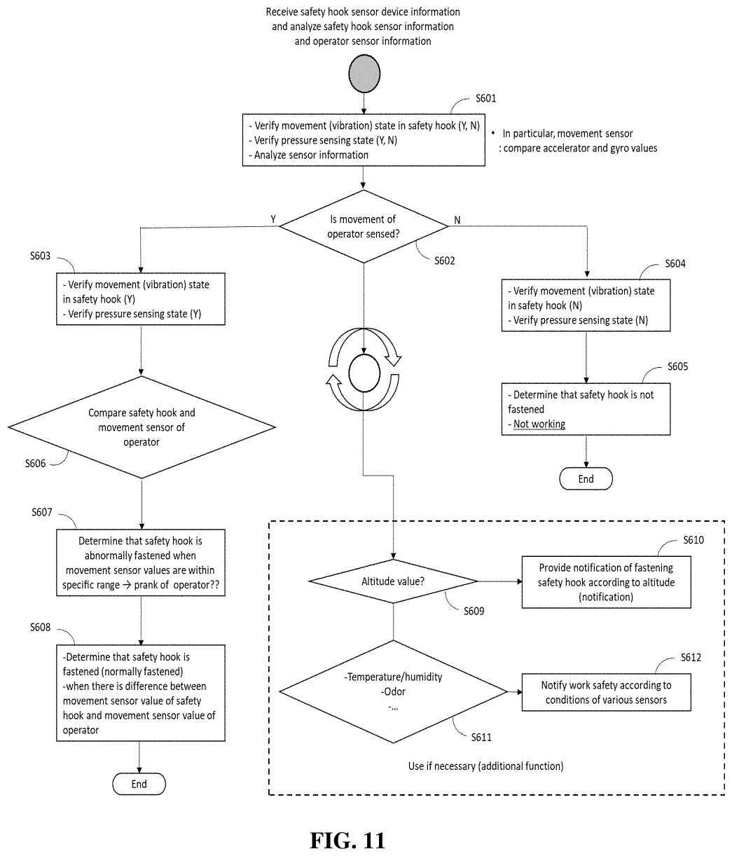

FIG. 11 is a flowchart illustrating an example of a safety hook fastening accident prevention method of a wearable sensor according to an example embodiment. Referring to FIG. 11, the wearable sensor 50 performs operation S601 of analyzing sensor information of a movement state and a pressure sensing state in the safety hook, operation S602 of sensing movement of the operator, operation S603 of determining that the movement state is yes and the pressure sensing state is yes in the safety hook when the movement is sensed, operation S604 of determining that the movement state is no and the pressure sensing state is no in the safety hook when the movement is not sensed, operation S605 of determining that the safety hook is not fastened when the movement state is no and the pressure sensing state is no, operation S606 of comparing the safety hook and a movement sensor of the operator, operation S607 of determining that the safety hook is abnormally fastened when movement sensor values are within a specific range, operation S608 of determining that the safety hook is normally fastened when the movement sensor values are outside the specific range, operation S609 of sensing altitude, operation S610 of providing a notification of fastening the safety hook according to the altitude, operation S611 of sensing air quality, and operation S612 of notifying a work safety according to conditions of various sensors.

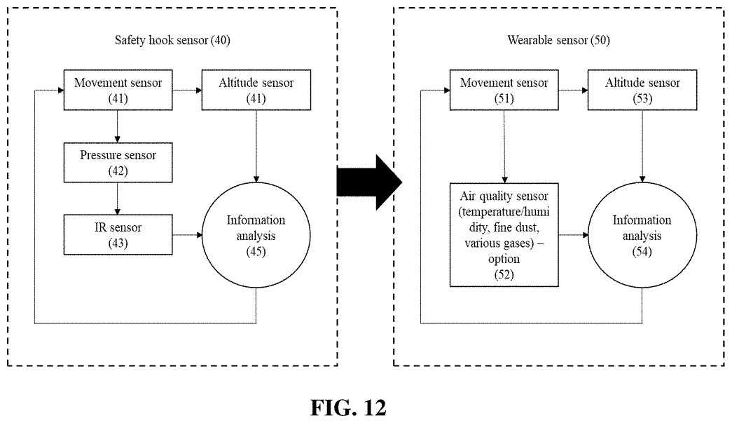

FIG. 12 is a diagram illustrating an example of a safety hook sensor and a wearable sensor according to an example embodiment. Referring to FIG. 12, the safety hook sensor 40 includes a movement sensor 41, a pressure sensor 42, the IR sensor 43, an altitude sensor 44, and an information analysis 45, and the wearable sensor 50 includes the movement sensor 51, an air quality sensor 52, the altitude sensor 53, and an information analysis 54.

The safety hook sensor 40 and the wearable sensor 50 may be worn by the operator. Alternatively, only the safety hook sensor 40 may be worn by the operator. In the case of configurating the safety hook fastening accident prediction system using only the safety hook sensor 40, a variety of intelligent context information and accuracy may slightly lack compared to simultaneously using the safety hook sensor 40 and the wearable sensor 50. The safety hook sensor 40 and the wearable sensor 50 may be simultaneously used to quickly predict various working conditions of the operator and risk. Also, since system cost, a workplace environment, the operator, and the like, are considered, it is possible to induce the safety of the operator even with the safety hook sensor 40 alone.

The safety hook sensor 40 includes the movement sensor 41 configured to sense movement, the pressure sensor 42 configured to measure applied pressure, the IR sensor 43 configured to measure a distance, the altitude sensor 44 configured to measure altitude, and the information analysis 45 configured to predict a fastening accident by analyzing information about the movement, the pressure, the distance, and the altitude, and the wearable sensor 50 includes the movement sensor 51 configured to sense movement, the air quality sensor 52 configured to sense air quality, the altitude sensor 53 configured to measure the altitude, and the information analysis 54 configured to predict a user status by analyzing information about the movement, the air quality, and the altitude.

Information of the safety hook sensor 40 is transmitted to the wearable sensor 50. Basically, information may be transmitted through wireless communication and may be transmitted in a wired manner depending on cases.

When the pressure is sensed by the safety hook sensor 40, it is generally recognized as safety hook fastening. Whether the safety hook is normally fastened or abnormally fastened may be determined using a plurality of convergence and fusion sensors. In particular, when fastening is sensed by pressure using the safety hook sensor 40, when a value of the movement sensor 41 of the safety hook sensor 40 and a value of the movement sensor 51 of the wearable sensor 50 are similarly sensed, that is, when a comparative change value is within a predetermined range, it is determined that the operator has fastened the safety hook to a body of the operator.

The central control server 70 may monitor information that appears on the wearable sensor 50 of the operator in real time and may analyze a physical condition of the operator. When the operator works at a high place, the risk may be determined based on a gait pattern, a speed, and a safety hook fastening condition of the operator. When such information is accumulated, it is possible to perform a risk sensing tailored for the corresponding operator.

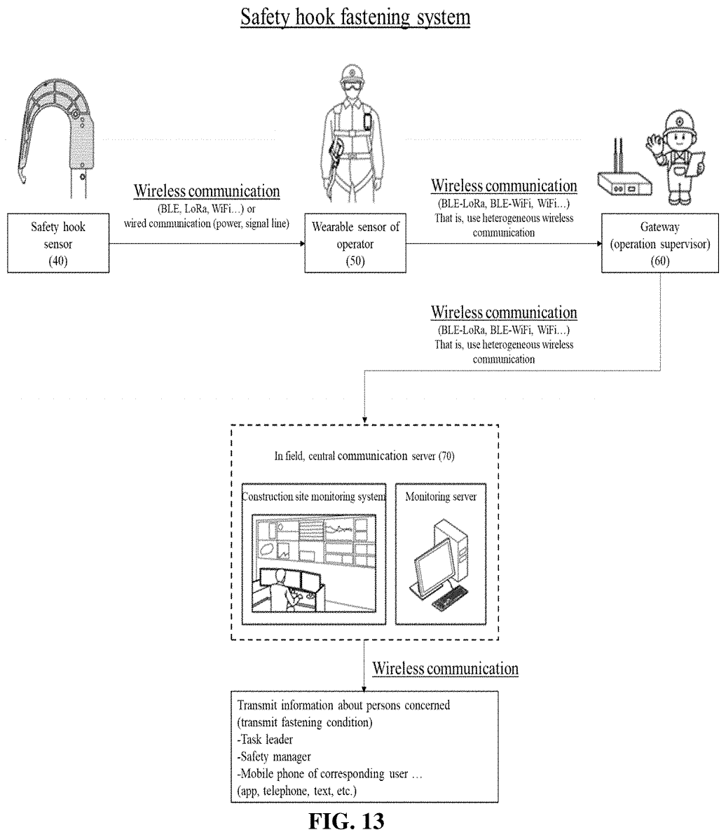

FIG. 13 illustrates a first embodiment of a safety hook fastening accident prevention system according to an example embodiment. Referring to FIG. 13, the safety hook fastening accident prevention system includes the safety hook sensor 40, the wearable sensor 50, the gateway 60, and the central control server 70.

The safety hook sensor 40 is mounted to a safety hook, predicts a fastening condition of the safety hook, and transmit the fastening condition the wearable sensor 50. The wearable sensor 50 receives the fastening condition from the safety hook sensor 40 and transmits the fastening condition to the central control server 70 through the gateway 60. The central control server 70 collects the fastening condition of the safety hook sensor 40 and manages the safety of the operator based on the collected information.

The gateway 60 may be a smartphone of the operator or a separate terminal. When the gateway 60 is the smartphone, an app is activated and transmits the fastening condition to a server. The gateway 60 may use various wireless communication protocols (LoRa, LTE, WiFi, and BT), and, if necessary, may simultaneously insert and use a heterogeneous wireless communication protocol. For example, BLE-LTE, BLE-LoRa, BLE-WiFi, and the like may be used.

Similar to the wireless communication of the gateway 60, the communication protocol of the safety hook sensor 40 may be variously applied. Brief information may be transmitted from the safety hook sensor 40 to the central control server 70 through the gateway 60 configured as the smartphone. In this case, various intelligent functions may be installed on a smartphone app and thereby serviced. For application of a wireless communication protocol, a most suitable system may be adopted in terms of securing data reliability according to a field condition.

The central control server 70 may be operated by a related institution, for example, a company, a police station, and a medical institution, and a person concerned may be an operator, a supervisor, or a controller.

The safety hook sensor 40 transmits data information using a method of periodically transmitting a fastening condition, a method of transmitting real-time information in response to occurrence of one of risk sensing, prediction, and accident, and a method of transmitting information in response to an information request from a server.

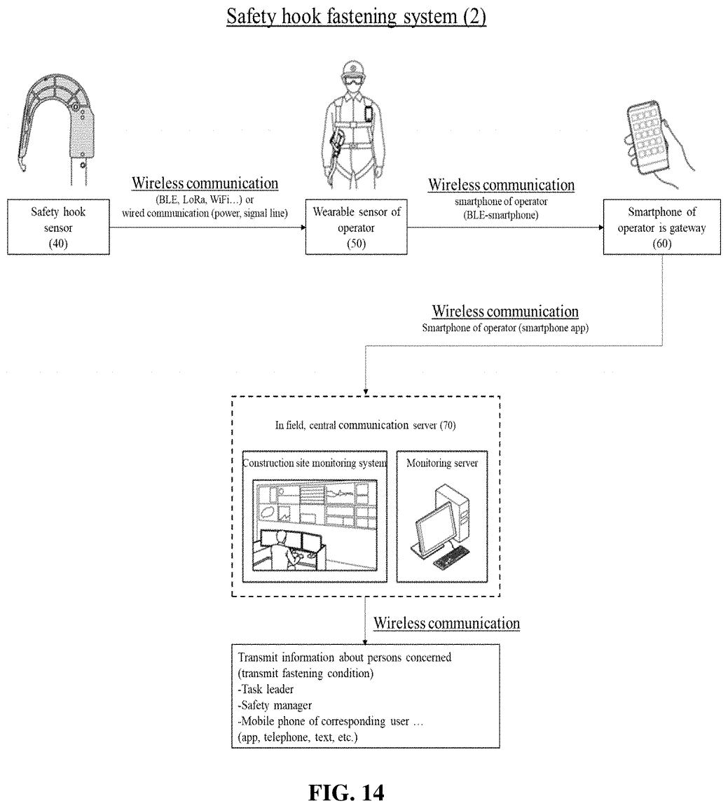

FIG. 14 illustrates a second embodiment of a safety hook fastening accident prevention system according to an example embodiment. Referring to FIG. 14, the safety hook fastening accident prevention system includes the safety hook sensor 40, the wearable sensor 50, the gateway 60, and the central control server 70.

The safety hook sensor 40 is mounted to the safety hook, predicts a fastening condition of the safety hook, and transmits the fastening condition to the wearable sensor 50. The wearable sensor 50 receives the fastening condition from the safety hook sensor 40 and transmits the fastening condition to the central control server 70 through the gateway 60. The central control server 70 collects the fastening condition of the safety hook sensor 40 and manages the safety of the operator based on the collected information.

The smartphone of the operator operates as the gateway 60.

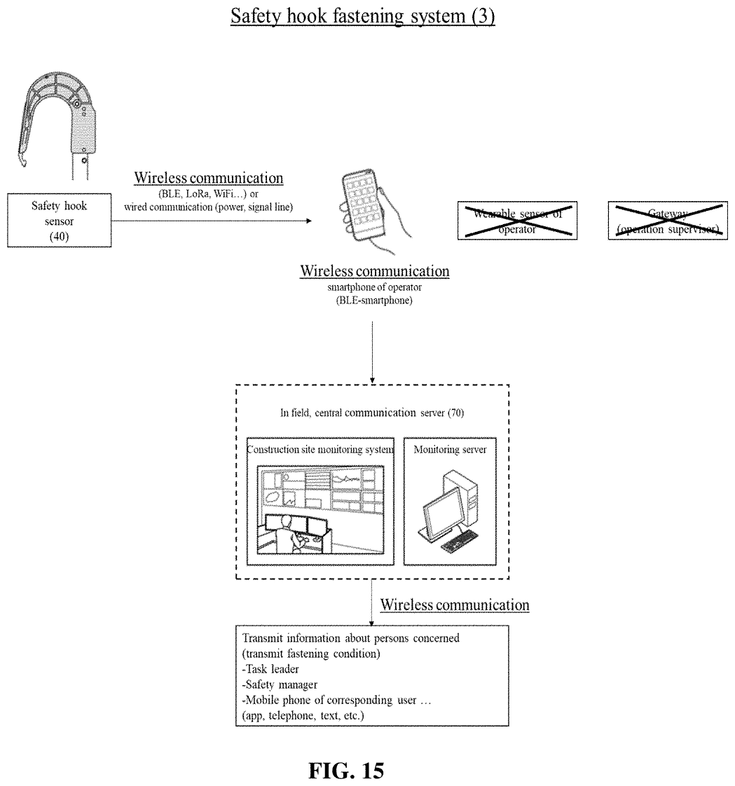

FIG. 15 illustrates a third embodiment of a safety hook fastening accident prevention system according to an example embodiment. Referring to FIG. 15, the safety hook fastening accident prevention system includes the safety hook sensor 40 and the central control server 70.

The safety hook sensor 40 is mounted to the safety hook, predicts a fastening condition of the safety hook, and transmits the fastening condition to the central control server 70. The central control server 70 collects the fastening condition of the safety hook sensor 40 and manages the safety of the operator based on the collected information.

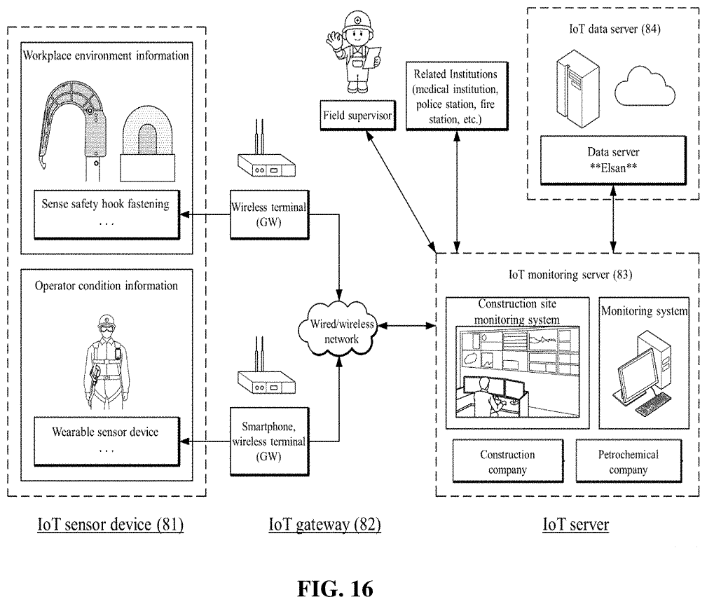

FIG. 16 illustrates an example of an Internet of things (IoT) configuration of a safety hook fastening accident prevention system according to an example embodiment. Referring to FIG. 16, the IOT configuration of the hook fastening accident prevention system includes an IoT sensor device 81, an IoT gateway 82, an IoT monitoring server 83, and an IoT data server 84.

The IoT sensor device 81 plays the role of the safety hook sensor 40, the IoT gateway 82 plays the role of the gateway 60, the IoT monitoring server 83 plays the role of the central control server 70, and the IoT data server 84 plays the role of a database that interacts with the central control server 70.

The IoT sensor device 81 transmits data information using a method of periodically transmitting a fastening condition, a method of transmitting real-time information in response to occurrence of one of risk sensing, prediction, and accident, and a method of transmitting information in response to an information request from a server.

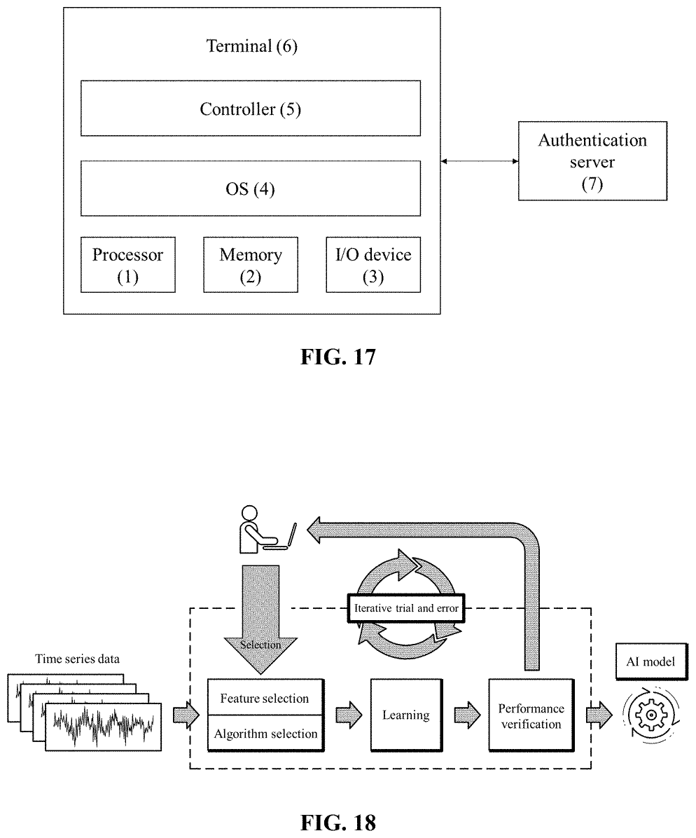

FIG. 17 is a diagram illustrating an example of an operation of a hardware resource, an operating system (OS), a controller that is a core, and a system authentication configuration to grant authority for executing the controller according to an example embodiment. Referring to FIG. 17, the present invention includes a processor 1, a memory 2, an input/output (I/O) device 3, an OS 4, and a controller 5.

The processor 1 refers to a central processing unit (CPU), a graphic processing unit (GPU), a field programmable gate array (FPGA), a neural processing unit (NPU) and performs an execution code for the OS 4 mounted to the memory 2 and the controller 5.

The memory 2 may include a permanent mass storage device, such as a random access memory (RAM), a read only memory (ROM), a disk drive, a solid state drive (SSD), and a flash memory.

The I/O device 3 may include a device, such as a camera including an audio sensor and/or an image sensor, a keyboard, a microphone, and a mouse as an input device, and may include a device, such as a display, a speaker, and a haptic feedback device, as an output device.

The OS 4 may include Windows, Linux, IOS, a virtual machine, a web browser, and an interpreter.

The controller 5 determines a state according to an input using a sensor, a key, a touch, and a mouse of the I/O device 3 under support of the OS 4, and performs an operation according to the determined state. The controller 5 performs a task scheduling by a timer and a thread as a parallel performance routine.

The controller 5 determines a state based on a sensor value of the I/O device 3 and performs an algorithm according to the determined state. The controller 5 applies an interval differentiation to sensor values of the pressure sensor 16 and the IR sensor 13 and performs a pressure and movement sensing algorithm according to increase/decrease settings. In the pressure and movement sensing algorithm, pressure and movement are sensed and reliability for sensing of a secondary sensor value is improved through settings of an increase and a decrease to which an interval differentiation for secondary sensing is applied for a primary sensor value level. The pressure sensor 16 may sense pressure. When a pressure intensity gradually increases, the pressure sensor 16 may output a pressure sensing signal although there is an increase or a decrease.

When the pressure and movement sensing algorithm is not applied to the pressure sensor 16 and the IR sensor 13, the controller 5 may monitor a trend and a change in a pressure sensing signal and a movement sensing signal of the pressure sensor 16 and the IR sensor 13 over time for the pressure sensing signal and the movement sensing signal and may generate pressure and movement sensing notification data according to the monitoring result.

Referring to FIG. 17, a system authentication configuration includes a terminal 6 that includes the controller 5 and an authentication server 7.

The terminal 6 duplexes a data channel, receives biometric information and a key value of the terminal 6, requests the authentication server 7 for user authentication through a first data channel, displays a generated kit value on a display and transmits the same to the authentication server 7.

The terminal 6 inputs the kit value displayed on the display of the terminal 6 and transmits the kit value to the authentication server 7 with user information through a second data channel. The terminal 6 requests the authentication server 7 for authentication of a system mounted to the terminal 6 using the kit value and the user information. The kit value of the terminal 6 may be generated from a MAC address of an Ethernet chip and a CPU serial number that is a unique information of a computer. The terminal 6 may acquire the user information through facial recognition using a camera, speech recognition using a microphone, and a handwriting recognition using the display and may use the acquired user information for authentication.

The authentication server 7 receives the kit value from the terminal 6, receives the kit value and the user information from the terminal 6 through the duplexed data channel, compares the received kit value and user information of the terminal 6, and processes authentication for a system use of the terminal 6 based on the user information. The authentication server 7 transmits an authentication result to the terminal 6 and allows the user to use the system. Due to the duplexed data channel of the terminal 6, loss of the kit value may be minimized.

The authentication server 7 performs history analysis of user information and compares and determines consistency and change of the user information over time. When the user information shows consistency as a result of the history analysis, the authentication server 7 allows the user to use the system. When the user information shows change as a result of the history analysis, the authentication server 7 does not allow the user to use the system. By allowing the user to use the system when the user information shows consistency, security may be reinforced to prevent a user with altered user information from accessing the system.

The terminal 6 that is a method of authenticating the use of the system may form a detour path through the authentication server 7 without directly connecting to the system. In this manner, when an Internet protocol (IP) address setting process is inconvenient since a network constituting an Internet network includes an internal network and an external network, an authentication process using the terminal 6 may be smoothly performed. Here, the system is mounted to the terminal 6, the terminal 6 functions as an authentication terminal method, and the authentication server 7 functions as an authentication server method.

The safety hook sensor 40 that is the terminal 6 may transmit a pressure sensing signal and may notify a danger signal through the authentication.

FIG. 18 illustrates an example of applying a neural network according to an example embodiment.

Neural network learning selects a model through an algorithm selection and a feature selection from time series data collected from input devices, for example, various sensors such temperature, altitude, and fingerprint sensors, a camera such as image and IR cameras, and lidar, and repeats a model selection through an iterative trial and error by a learning and a performance verification process. Once the performance verification is completed, an artificial intelligence (AI) model is selected.

The controller 5 performs a deep learning algorithm by applying a neural network to a sensor value determination, uses training data for neural network learning, and verifies performance of the neural network using test data.

The central control server 70 that includes the controller 5 with the neural network collects information about pressure, movement, altitude, and air quality from the safety hook sensor 40 and the wearable sensor 50, performs statistical analysis, neural network learning, and pattern analysis based on the collected information, and provides a manager with a safety hook fastening condition and a risk sensing according to the analysis result.

Six machine learning algorithms, for example, a linear discriminant analysis (LDA), a logistic regression (LR), a support vector machine (SVM), a decision tree (DT), a k-nearest neighbor (KNN), and a random forest (RF), may be applied to the statistical analysis, the neural network learning, and the pattern analysis. The linear discriminant analysis (LDA) estimates and predicts a probability that a new input set belongs to each class. A class corresponding to a highest probability is an output class and a prediction is performed. The logistic regression (LR) is a probability about two possible classification issues.

The support vector machine (SVM) finds a hyperplane decision boundary that best divides the sample into two classes. Division is smoothly performed using a white space into which some points may be misclassified. The decision tree (DT) involves a task that grows a tree to classify an example of a training data set. The tree may be regarded as dividing the training data set. Here, referring to the example, a class label is allocated by proceeding along a decision point of the tree and reaching a leaf of the tree. The k-nearest neighbor (KNN) stores all the available data and classifies new data points based on similarity. That is, when new data appears, the new data may be easily classified into a well-suite category using the k-nearest neighbor (KNN). Also, the random forest (RF) includes many decision trees for a final output. Here, since a large number of decision trees participate into the process, the random forest (RF) is regarded as a very accurate and robust method.

Using a machine learning algorithm, the central control server 70 may analyze a change in a sensor value of the safety hook sensor 40 and a sensor value of the wearable sensor 50 and may also analyze a correlation related to two sensor values.

Although a number of example embodiments have been described above, it will be apparent to one of ordinary skill in the art that various alterations and modifications in form and details may be made in these example embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A safety hook fastening condition prediction system comprising:
a safety hook sensor configured to mount to a safety hook, to predict a fastening condition of the safety hook, and to transmit the fastening condition to a central control server through a connection of a safety hook zone and a safety hook sensor case through a central axis; and
the central control server configured to collect the fastening condition of the safety hook sensor and to manage a safety of an operator based on collected information.

2. The safety hook fastening condition prediction system of claim 1, wherein the central axis is formed on a curved body portion that bends outward from a locking space of the safety hook zone and is configured to sense pressure in all of a vertical direction and a horizontal direction.

3. The safety hook fastening condition prediction system of claim 1, wherein a hole is formed in the safety hook zone to form the central axis.

4. The safety hook fastening condition prediction system of claim 1, wherein a spring is configured to insert into a spring insertion groove and to increase elasticity and reliability for pressure sensing between the safety hook zone and the safety hook sensor case.

5. The safety hook fastening condition prediction system of claim 1, wherein the safety hook sensor is configured to mount to the safety hook, to predict the fastening condition of the safety hook, and to transmit the fastening condition to a wearable sensor, the wearable sensor is configured to receive the fastening condition from the safety hook sensor and to transmit the same to the central control server through a gateway, and the central control server is configured to collect the fastening condition of the safety hook sensor and to manage the safety of the operator based on the collected information.

6. The safety hook fastening condition prediction system of claim 1, wherein the safety hook sensor comprises a pressure sensor, and
the pressure sensor comprises:
a printed circuit board (PCB) configured to sense pressure;
a conductive silicone having elasticity; and
a silicone pressure case having elasticity configured and configured to surround the PCB and the conductive silicone.

7. The safety hook fastening condition prediction system of claim 1, wherein the safety hook sensor comprises a pressure sensor, and
the pressure sensor comprises:
a PCB comprising switches and resistances capable of sensing pressure; and
a silicone pressure case having elasticity and configured to surround the PCB.

8. The safety hook fastening condition prediction system of claim 1, wherein the safety hook sensor is configured to perform:
operation of sensing pressure;
operation of determining that the safety hook is fastened when the pressure is sensed;
operation of determining that the safety hook is not fastened when the pressure is not sensed;
operation of determining whether a pressure change is present during a predetermined period of time when the safety hook is fastened;
operation of determining a corresponding situation as an operator pressure condition manipulation when the pressure change is absent;
operation of determining a corresponding situation as a risk situation; and
operation of determining a corresponding situation as a normal fastening when the pressure change is present.

9. The safety hook fastening condition prediction system of claim 1, wherein the safety hook sensor is configured to perform:
operation of sensing movement;
operation of sensing altitude;
operation of determining that the safety hook is in a moving state when a danger area is yes and the movement is sensed;
operation of determining that the safety hook is in a stop state when the danger area is no and the movement is not sensed;
operation of sensing pressure;
operation of determining that the safety hook is fastened when the pressure is sensed;
operation of determining whether a pressure change is present during a predetermined period of time when the safety hook is fastened;
operation of determining a corresponding situation as an operator pressure condition manipulation when the pressure change is absent;
operation of determining a corresponding situation as a risk situation;
operation of determining a corresponding situation as a normal fastening when the pressure change is present;
operation of determining that the safety hook is not fastened when the pressure is not sensed;
operation of determining whether a movement change is present during a predetermined period of time when the safety hook is not fastened;
operation of determining a corresponding situation as a risk situation when the movement change is present; and
operation of determining that the safety hook is not used when the movement change is absent.

10. The safety hook fastening condition prediction system of claim 1, wherein the safety hook sensor is configured to perform:
operation of sensing movement;
operation of determining that the operator or the safety hook is in a moving state when the movement is sensed;
operation of determining that the operator or the safety hook is in a stop state when the movement is not sensed;
operation of sensing pressure;
operation of sensing an object using an infrared (IR) sensor;
operation of determining that the safety hook is fastened when the object or the pressure is sensed;
operation of determining that the safety hook is not fastened when the object or the pressure is not sensed;
operation of determining whether the pressure change is present during a predetermined period of time when the safety hook is fastened;
operation of determining a corresponding situation as an operator pressure condition manipulation when the pressure change is absent;
operation of determining a corresponding situation as a risk situation;
operation of determining a corresponding situation as a normal fastening when the pressure change is present;
operation of determining whether a movement change is present during a predetermined period of time when the safety hook is not fastened;
operation of determining a corresponding situation as a risk situation when the movement change is present; and
operation of determining that the safety hook is not used when the movement change is absent.

11. The safety hook fastening condition prediction system of claim 1, wherein the safety hook sensor is configured to perform:
operation of sensing movement;
operation of sensing altitude;
operation of determining that the operator or the safety hook is in a moving state when a danger area is yes and the movement is sensed;
operation of determining that the operator or the safety hook is in a stop state when the danger area is no and the movement is not sensed;
operation of sensing an object using an IR sensor;
operation of determining that the safety hook is fastened when the object is sensed;
operation of determining that the safety hook is not fastened when the object is not sensed;
operation of determining whether a pressure change is present during a predetermined period of time when the safety hook is fastened;
operation of determining a corresponding situation as an operator pressure condition manipulation when the pressure change is absent;
operation of determining a corresponding situation as a risk situation;
operation of determining a corresponding situation as a normal fastening when the pressure change is present;
operation of determining whether a movement change is present during a predetermined period of time when the safety hook is not fastened;
operation of determining a corresponding situation as a risk situation when the movement change is present;
operation of determining that the safety hook is not used when the movement change is absent; and
operation of transmitting information to an operator sensor device.

12. The safety hook fastening condition prediction system of claim 1, wherein the safety hook sensor is configured to perform:
operation of sensing movement;
operation of sensing altitude;
operation of determining that the operator or the safety hook is in a moving state when the movement is sensed;
operation of determining that the operator or the safety hook is in a stop state when the movement is not sensed;
operation of sensing pressure;
operation of sensing an object using an IR sensor;
operation of determining that the safety hook is fastened when the pressure is sensed;
operation of determining that the safety hook is not fastened when the pressure is not sensed;
operation of determining whether the pressure change is present during a predetermined period of time when the safety hook is fastened;
operation of determining a corresponding situation as an operator pressure condition manipulation when the pressure change is absent;
operation of determining a corresponding situation as a risk situation;
operation of determining a corresponding situation as a normal fastening when the pressure change is present;
operation of determining whether a movement change is present during a predetermined period of time when the safety hook is not fastened;
operation of determining a corresponding situation as a risk situation when the movement change is present; and
operation of determining that the safety hook is not used when the movement change is absent.

13. The safety hook fastening condition prediction system of claim 1, wherein the safety hook sensor is configured to monitor a change in a position of the operator using an altitude sensor and a reference altitude sensor and to provide an operator safety service based on at least one of a height of the operator, a reference point (ground), a safety hook fastening condition of the operator, a physical condition of the operator, and an environmental condition (weather).

14. The safety hook fastening condition prediction system of claim 1, wherein the safety hook sensor is configured to monitor a change in a position of the operator using a movement sensor and to provide an operator safety service based on at least one of a safety hook fastening condition of the operator, a physical condition of the operator, and an environmental condition (weather).

15. The safety hook fastening condition prediction system of claim 5, wherein the wearable sensor is configured to perform:
operation of analyzing sensor information of a movement state and a pressure sensing state in the safety hook;
operation of sensing movement of the operator;
operation of determining that the movement state is yes and the pressure sensing state is yes in the safety hook when the movement is sensed;
operation of determining that the movement state is no and the pressure sensing state is no in the safety hook when the movement is not sensed;
operation of determining that the safety hook is not fastened when the movement state is no and the pressure sensing state is no;
operation of comparing the safety hook and a movement sensor of the operator;
operation of determining that the safety hook is abnormally fastened when a movement sensor value is within a specific range;
operation of determining that the safety hook is normally fastened when the movement sensor value is outside the specific range;
operation of sensing altitude;
operation of providing a notification of fastening the safety hook according to the altitude;
operation of sensing air quality; and
operation of notifying a work safety according to conditions of various sensors.
